(19) United States
(12) Patent Application Publication
(10) Pub. No.: US 2026/0017553 A1
(43) Pub. Date: Jan. 15, 2026

(54) Enhancing Combinatorial Optimization with Quantum Generative Models

(71) Applicant: Zapata Computing, Inc., Boston, MA (US)

(72) Inventors: Francisco Javier Fernandez ALCAZAR, Toronto (CA); Alejandro PERDOMO-ORTIZ, Toronto (CA)

(21) Appl. No.: 18/617,014

(22) Filed: Mar. 26, 2024

Related U.S. Application Data
(63) Continuation of application No. 17/544,415, filed on Dec. 7, 2021.
(60) Provisional application No. 63/122,163, filed on Dec. 7, 2020.

(51) Int. Cl. G06N 10/60; G06N 3/045

(52) U.S. Cl. CPC G06N 10/60; G06N 3/045

(57) ABSTRACT

A system and method for a quantum-enhanced optimizer (QEO) using quantum generative models to achieve lower minimum cost functions than classical or other known optimizers. In a first embodiment, the QEO operates as a booster to enhance the performance of known stand-alone optimizers in complex instances where known optimizers have limitations. In a second embodiment, the QEO operates as a stand-alone optimizer for finding a minimum with the least number of cost-function evaluations. The disclosed QEO methods outperform known optimizers, including Bayesian optimizers. The disclosed quantum-enhanced optimization methods may be based on tensor networks. The generative models may also be based on classical, quantum, or hybrid quantum-classical approaches, including Quantum Circuit Associative Adversarial Networks (QC-AAN) and Quantum Circuit Born Machines (QCBM).

### BACKGROUND

### Field of the Invention

The field of the invention is quantum combinatorial optimization.

### Description of Related Art

The subject matter discussed in this section should not be assumed to be prior art merely as a result of its mention in this section. Similarly, any problems or shortcomings mentioned in this section or associated with the subject matter provided as background should not be assumed to have been previously recognized in the prior art. The subject matter in this section merely represents different approaches, which in and of themselves can also correspond to implementations of the claimed technology.

Combinatorial optimization is one of top candidates in the race for practical quantum advantage. Quantum-assisted or quantum-inspired algorithms may outperform traditional classical algorithms in a real-world application having a commercial or scientific value. A number of techniques have been developed to address optimization problems with quantum subroutines, including algorithms tailored for quantum annealers and gate-based quantum computers. However, these various approaches have drawbacks. Regardless of the quantum optimization approach used, there is a need to translate real-world problems into a polynomial unconstrained binary optimization (PUBO) expression, which is not necessarily straightforward and usually results in an overhead in terms of the number of variables. Therefore, to achieve computational advantage in the near-term, it is desirable to find an optimization strategy that can work on arbitrary objective functions, bypassing the translation and overhead limitations. The disclosed technology overcomes the drawbacks of prior approaches.

### SUMMARY

The disclosed technology offers a solution to these challenges using quantum enhanced optimizers (QEOs), which are scalable for handling highly complex problems. Combinatorial optimization problems are especially difficult to solve in real-world settings using classical or known optimizers. Embodiments of quantum-enhanced optimizers (QEOs) are disclosed that use quantum machine-learning models known as quantum generative models, which can find lower minima than those found by means of classical or known optimizers, including stand-alone, state-of-the-art classical solvers or optimizers. In the present context, the terms optimizer and solver are used synonymously for purposes of the following disclosure.

The disclosed technology provides two embodiments for quantum-enhanced optimization (QEO). The first embodiment boosts the performance of classical and known optimizers by using a quantum generative model. In the first embodiment, the QEO operates as a booster to enhance the performance of known stand-alone optimizers in complex instances where known optimizers have limitations and are incapable of providing the desired results in a stand-alone mode. The quantum generative model is based on unsupervised machine learning methods.

The second embodiment operates as a stand-alone QEO optimizer. The stand-alone optimizer exhibits improved performance when the purpose of the optimizer is to find the best minimum within the least number of cost function evaluations. The disclosed quantum enhanced optimization methods outperform classical and known optimizers, including Bayesian optimizers which are known to be one of the best competing solvers in such tasks.

The quantum generative models are based on tensor networks (TN). The quantum generative models are capable of generating new “unseen” solution candidates which have the potential for a lower value for the objective function then those already “seen” and used as the training step in training the generative model. This is a desirable feature of any practical machine learning (ML) model.

Another advantage of the present technology is that it can utilize available observations obtained from prior attempts to solve the optimization problem. These initial evaluations can originate from any source, including random search trials to tailored state-of-the-art classical optimizers tailored to specific problems.

Embodiments of the present invention implement a generative model based on Matrix Product States (MPS) to learn target distributions. MPS is a type of Tensor Network (TN) where the tensors are arranged in a one-dimensional geometry. Despise its simple structure, MPS can represent a large number of quantum states extremely well. Once the MPS form of the wavefunction Y′ is chosen, learning can be achieved by adjusting parameters of the wavefunction such that the distribution represented by Born's rule is as close as possible to the data distribution. MPS uses a direct sampling method that is more efficient than other Machine Learning (ML) methods, for instance, Boltzmann machines, which require Markov Chain Monte Carlo (MCMC) methods for data generation.

In one aspect, there is a general method for solving combinatorial optimization problems using a hybrid quantum-classical computing system. A first data set is generated comprising a plurality of bit string data elements from a prior probability distribution. Unsupervised training is performed, using the first data set to generate a quantum generative model. Using the trained quantum generative model, new bit string samples are generated and filtered according to properties of the bit string samples. The bit string samples are evaluated and selected based on the cost function values of the new bit string samples. The first data set is merged with the selected bit string samples to create a second data set. The steps are repeated iteratively so that the second data set is used to update the quantum generative model until a limiting number of iterations is reached. The number of iterations may also be a predetermined number.

In another aspect, the properties of the bit string samples may include cardinality constraints. Also, the properties of the bit string samples may include frequency of appearance. In a further aspect, the prior probability distribution comprises initial observations and cost function values. The initial observations may be drawn from randomly selected data elements in the first dataset. In another aspect, matrix product states (MPS) may be used for building the quantum generative model. Also, the quantum generative model may be implemented as a tensor network (TN).

In one embodiment, the quantum generative model is a quantum-assisted generative adversarial network (GAN). In another aspect, the bit string samples are evaluated based on minimizing cost function values.

In one embodiment the method and system may be practiced in a stand-alone mode (i.e., the initial dataset is not received from a first optimizer) and the required number of cost function evaluations are reduced over classical and other known optimizers. In another embodiment, a booster mode, the initial dataset is provided by the output of a first optimizer and the method, practiced as a second optimizer, boosts the performance of the first optimizer. In this embodiment, the method and system of the second optimizer achieve lower minima than the first optimizer. The first optimizer may be a classical optimizer.

In another aspect, a hybrid quantum-classical computer system is disclosed for performing a method for solving combinatorial optimization problems. The system includes a quantum computer, which comprises a plurality of qubits. The system includes a classical computer having a processor, a non-transitory computer-readable medium, and computer instructions stored in the non-transitory computer-readable medium. The computer instructions, when executed by the processor of the hybrid quantum-classical computer, execute a method for solving combinatorial optimization problems. A first data set is generated comprising a plurality of bit string data elements from a prior probability distribution. Unsupervised training is performed, using the first data set to generate a quantum generative model. Using the trained quantum generative model, new bit string samples are generated and filtered according to properties of the bit string samples. The bit string samples are evaluated and selected based on the cost function values of the new bit string samples. The first data set is merged with the selected bit string samples to create a second data set. The steps are repeated iteratively so that the second data set is used to update the quantum generative until a limiting number of iterations is reached. The number of iterations may also be a predetermined number.

In another embodiment, the system further includes a Quantum Circuit Associative Adversarial Network (QC-AAN). In another further embodiment, the system further includes a Quantum Circuit Born Machines (QCBM). In another aspect, the quantum generative model may be implemented using gate-based quantum circuits. In another aspect, the generative model may also be a quantum-assisted generative adversarial network (GAN).

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention;

FIG. 3 is a diagram of a hybrid quantum-classical computer according to one embodiment of the present invention;

FIG. 4 illustrates in block diagram form the general data flow for using QEO;

FIG. 5 illustrates the structure and data flow of the disclosed the quantum enhanced optimizer (QEO);

FIG. 6 illustrates the pseudocode for the first embodiment of the quantum enhanced optimization (QEO) algorithm for a stand-alone optimizer; and

FIG. 7 illustrates the pseudocode for the second embodiment of the quantum enhanced optimization (QEO) algorithm used as an enhancer or boost optimizer.

### DETAILED DESCRIPTION

Quantum-Enhanced Optimization with Generative Models

The present technology uses a quantum generative model based on tensor networks TNs to test and scale the disclosed QEO method with a number of variables commensurate with those found in industrial-scale scenarios. For the training of the QEO models, Matrix Product States (MPS) are used to build an unsupervised generative model.

The disclosed technology may operate in either of two modes: a boosted mode, or stand-alone mode. In boosted mode, past observations are derived from classical and known solvers. In stand-alone mode, all initial cost function evaluations are decided entirely by the quantum-inspired generative model, and a random prior is constructed to give support to the target probability distribution the MPS model is aiming to capture.

In one aspect, there is a general method for solving combinatorial optimization problems using a hybrid classical-quantum computing system. A first data set is generated comprising a plurality of bit string data elements from a prior probability distribution. Unsupervised training is performed, using the first data set to generate a quantum generative model. Using the trained quantum generative model, new bit string samples are generated and filtered according to properties of the bit string samples. The new bit string samples are evaluated and selected based on the cost function values of the new bit string samples. The first data set is merged with the selected bit string samples to create a second data set. The steps are repeated iteratively so that the second data set is used to update the quantum generative until a limiting number of iterations is reached. The number of iterations may also be a predetermined number.

In another aspect, a hybrid quantum-classical computer system is disclosed for performing a method for solving combinatorial optimization problems. The system includes a quantum computer comprises a plurality of qubits. The system includes a classical computer having a processor, a non-transitory computer-readable medium, and computer instructions stored in the non-transitory computer-readable medium. The computer instructions, when executed by the processor, perform, on the hybrid quantum-classical computer, execute a method for solving combinatorial optimization problems. A first data set is generated comprising a plurality of bit string data elements from a prior probability distribution. Unsupervised training is performed, using the first data set to generate a quantum generative model. Using the trained quantum generative model, new bit string samples are generated and filtered according to properties of the bit string samples. The new bit string samples are evaluated and selected based on the cost function values of the new bit string samples. The first data set is merged with the selected bit string samples to create a second data set. The steps are repeated iteratively so that the second data set is used to update the quantum generative until a limiting number of iterations is reached. The number of iterations may also be a predetermined number.

Unsupervised Generative Modeling using MPS

Embodiments of the present invention implement a generative model based on Matrix Product States (MPS) to learn target distributions, i.e., |Ψ(s)|²≈Target Distribution

$$P ( s ) = \frac{{\vert Ψ ( s ) \vert}^{2}}{Z} with Z = {\sum }_{s ∈ S} {\vert Ψ ( s ) \vert}^{2}$$

MPS is a type of Tensor Network (TN) where the tensors are arranged in a one-dimensional geometry. Despise its simple structure, MPS can represent a large number of quantum states extremely well. Once the MPS form of the wavefunction Ψ is chosen, learning can be achieved by adjusting parameters of the wavefunction such that the distribution represented by Born's rule is as close as possible to the data distribution. MPS enjoys a direct sampling method that is more efficient than other Machine Learning techniques, for instance, Boltzmann machines, which require which require a Markov Chain Monte Carlo (MCMC) process for data generation.

The rationale behind this approach resides in considering the target distribution as analogous to the surrogate function in Bayesian Optimization (BO), used to describe the landscape of the objective function.

The method for training the MPS includes adjusting the value of the tensors composing the MPS as well as the bond dimension among them, via the minimization of the negative log-likelihood function defined over the training dataset sampled from the target distribution:

$$ℒ = - \frac{1}{\vert S \vert} {\sum }_{s ∈ S} ln P ( s )$$

At the core of the solution to the ML problem lies optimizing the function parameters such that they perform well for all potentially observable data generated by the process. This property is commonly referred to as generalization and discriminates ML from pure optimization.

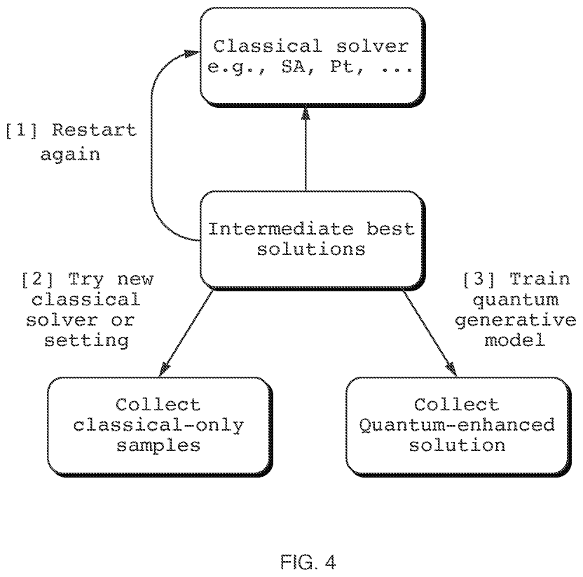

FIG. 4 illustrates in block diagram form the general data flow of quantum enhanced optimizer QEO. The illustration highlights the available strategies the user might explore a user might explore when solving a combinatorial optimization problem with a suite of classical optimizers such as simulated annealing (SA), parallel tempering (PT), generic algorithms (GA), among others. In the basic strategy, (not shown) the user would use its computational budget with a preferred solver. In strategies 1-2, the user would inspect intermediate results and decide whether to keep trying with the same solver (strategy 1). Alternatively, the user may try a new solver or a new setting of the same solver used to obtain the intermediate results (strategy 2). Finally, using the disclosed technology, acquired data will be used to train a quantum enhanced generative model within a QEO framework such as TN-QEO (strategy 3).

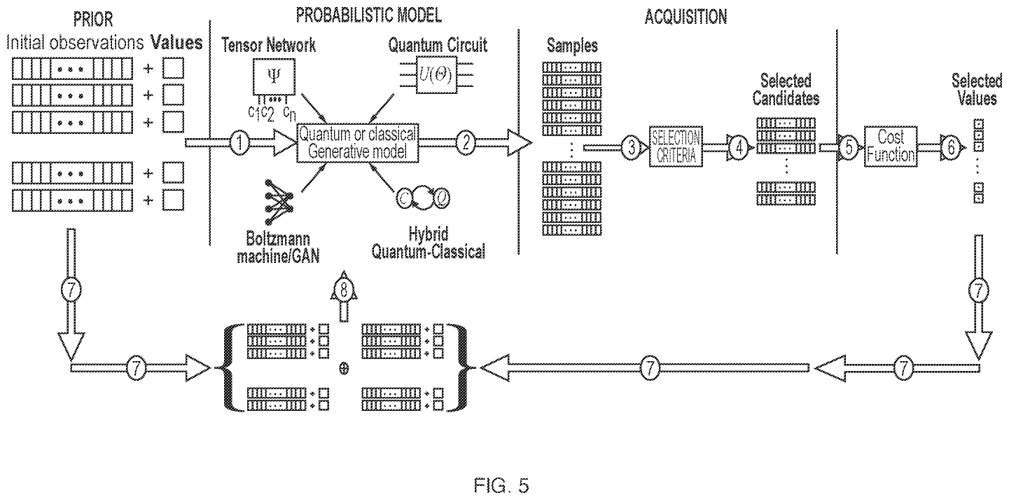

FIG. 5 provides an overview of the algorithm methodology for the quantum enhanced optimization method. The QEO framework leverages generative models to utilize previous samples coming from any classical or quantum solver to propose candidate solutions which might be out of reach for conventional solvers. The prior initial observations and cost function values serves as a prior distribution from which the training set samples are withdrawn to train the generative model (steps 1-3). A tensor-network (TN) based generative model is central to one embodiment of the method referred hereafter as TN-QEO. Other families of generative models from classical, quantum, or hybrid quantum-classical may also be used. The quantum-enhanced generative model is used to capture the main features in training set, and propose new solution candidates which are subsequently post selected before their costs are evaluated (steps 4-6). The new dataset is then merged with the first dataset (step 7) to form an updated (second) dataset (step 8) which is to be used in the next iteration of the algorithm.

### Algorithm Methodology for Solver I

This section presents an algorithm for the Tensor Network Quantum Enhanced Optimizer scheme (TN-QEO) according to one embodiment of the present invention. In optimization problems where the objective function is inexpensive to evaluate, it can be probed it at many points in the search for a minimum. However, if function evaluation is expensive, e.g., tuning hyperparameters of a deep neural network, then it is important to minimize the number of evaluations drawn. This is the domain where an optimization technique with a Bayesian flavor is most useful, where the search is being conducted based on new information gathered in the attempt to find the global optimum in a minimum number of steps.

The algorithm incorporates a prior distribution constructed as a Boltzmann distribution whose Boltzmann weights are estimated with the risk values of the portfolio candidates.

Therefore, as desired, portfolio candidates whose risks are low will be favored and tend to appear more frequently than those with high-risk values. These samples from the Boltzmann model constitute only the training set that will be passed to the generative model. As indicated in the main text, all of our testing and simulations of the quantum generative model are performed by using a tensor network; in particular, Matrix Product States (MPS). Analogously to the role of the so-called acquisition function in Bayesian Optimization (BO), a key point in the present model is the use of the MPS to direct sampling areas where an improvement over the current best observation is likely.

The new candidates go through a selection criterion before these are evaluated and subsequently appended to the original dataset from which a Boltzmann posterior is constructed and from which samples are taken as the training for the new algorithmic cycle,

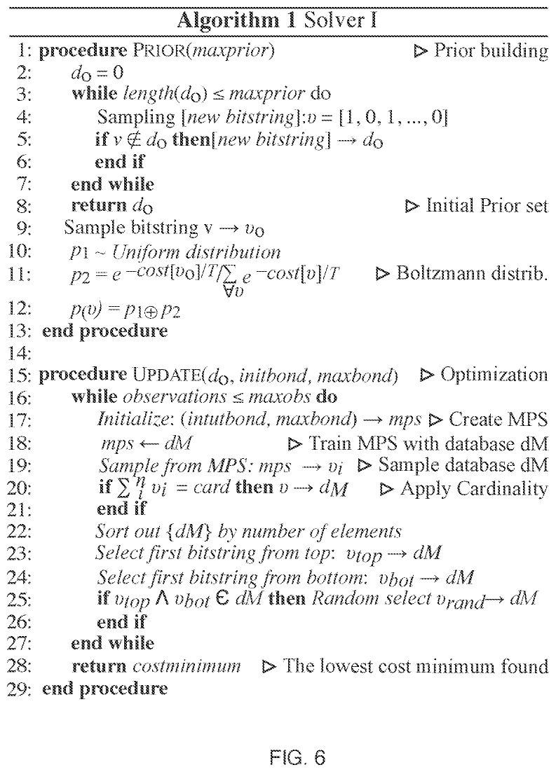

FIG. 6 illustrates the pseudo-code for a full algorithm implemented according to one embodiment of the present invention. The algorithm of FIG. 6 is illustrative only and does not constitute a limitation of the present invention. The steps in the algorithm are broken down as follows:
1. Build an initial dataset, d₀, with uniformity probability distribution,

$${p}_{0} = \frac{1}{{n}_{init}} ,$$

where nᵢ represents the size of d₀. All the elements in this dataset should hold the cardinality condition, i.e., the maximum length of d₀ could be

$$( \begin{matrix}N \\ κ\end{matrix} ) .$$

2. Randomly select a point from the set do, and evaluate the value of its objective function c₁≡σ₁ (the risk value in our specific finance example). Use this value along with the temperature hyperparameter to determine the initial cost c₀ associated to the rest of nᵢₙᵢₜ−1 points in d₀. This value is calculated, for this setting, under the assumption that the probability associated to c₁ (denoted as p₁=e^{-c}^{₁}^{/T}/Z) is twice the Boltzmann weight associated to any of the other points in d₀ (denoted as p₀′=e^{-c}^{₀}^{/T}/Z). Note that c₀ is an artificial risk value which serves only as to initialize the support of the prior distribution. Sample from the initial dataset using the constructed probability distribution to create a set of bit strings d_{M} which will be used as initial set to train the MPS.
3. Train the MPS with the bit string dataset.
4. From the trained MPS generate samples and filter those bit strings that hold cardinality.
5. Sort those bit strings by frequency of appearance in the dataset, meaning that the more frequent bit strings correspond to a higher Boltzmann probability, and consequently lower risk and sequentially searching from the top bit-string until finding one that does not belong in the current dataset d_{M}. Then, repeat the same procedure starting from the bottom moving upward, appending the first bit string that does not belong in d_{M}. Note that it could happen that any of these two bitstring may coincide, in which case only one bit string is selected. If no new element to the dataset is found, following the previous two items, then randomly select one new bit string from the full space of bit strings.
6. Compute the cost for these two new bit strings, and recalculate the associated Boltzmann distribution. The new elements may be inside or outside of the current dataset, and a new normalization factor is required for the Boltzmann distribution.
7. Append the new proposed bit strings to dataset d_{M}.
8. Sample for the above set using its computed cost function (Boltzmann distribution) creating the new dataset to feed the MPS in its next training cycle.
9. Repeat the process from step (2) to (8), inclusive, with the output from step (8) as new input for step (2) every for new iteration after the initial one until reaching the predetermined maximum number of observations.

### Algorithm Methodology for Solver II

In this second application of the optimizer the goal is to use it as an enhancer or boost optimizer. To that effect, it may be considered a variant of the two-steps previous algorithm, where the first step, the prior construction, is now substituted for the result from another classical optimizer—in the case here studied it corresponds to Simulating Annealing—and the second step it is understood as a continuation in the search for a lower minimum, now guided by the MPS update step. In this case it is assumed that the cost of evaluating the objective function is not high, and consequently there is no practical limitations in the number of observations, the number of cost evaluation of the Boltzmann distribution, to be taken.

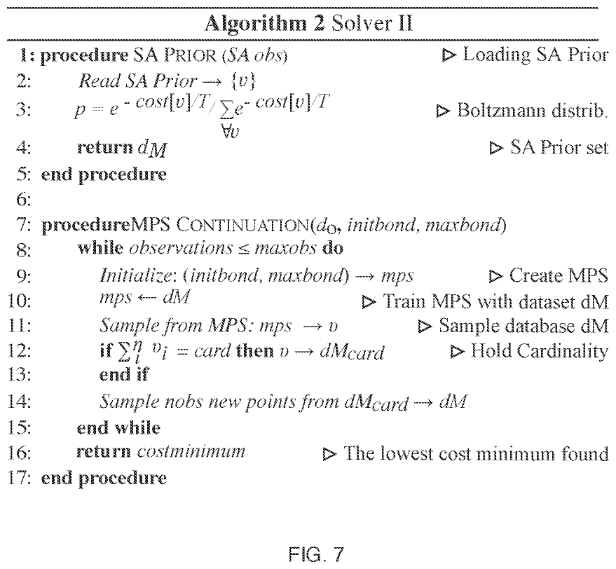

FIG. 7 illustrates the pseudo-code for a full algorithm implemented according to one embodiment of the present invention. The algorithm of FIG. 7 is illustrative only and does not constitute a limitation of the present invention. The method of FIG. 7 follows fundamentally the same procedure as the prior 1 method, with the only two differences. In this method, the prior is constructed via Simulated Annealing instead of the Random procedure explained above. Also, the acquisition stage differs in that the new bit string candidates corresponds simply to sample a predetermined number of them from the trained MPS. The steps in the algorithm are broken down as follows.
1. Read in prior from Simulating Annealing and compute corresponding Boltzmann probability distribution, and sort it by descending probability.
2. Select the top n bit strings from prior above to create the initial database d_{M}
3. Create MPS and train it with dataset.
4. Sample nₘₚₛ bit strings from trained MPS, and filter those holding cardinality condition.
5. Sample n_{obs} bit strings, add them up to d_{M}, and compute their cost function.
6. Report the minimum found thus far.
7. Repeat the process from creating an MPS onwards until the predetermined number of observations, n_{obs,max} is reached.

One aspect of the present invention is directed to a method performed by a computer system for solving combinatorial optimization problems. The computer system includes a classical computer. The classical computer includes a processor, a non-transitory computer-readable medium, and computer instructions stored in the non-transitory computer-readable medium. The computer program instructions are executable by the processor to perform the method. The method includes: (a) generating a first dataset, the first dataset comprising a plurality of bit string samples from a prior probability distribution, (b) performing unsupervised training using the first dataset to generate a quantum generative model; (c) using the quantum generative model to generate a plurality of new bit string samples; (d) filtering the new bit string samples according to properties of the plurality of new bit string samples to produce a plurality of filtered bit string samples; (c) applying a cost function to the plurality of filtered bit string samples to produce a plurality of cost function values of the plurality of filtered bit string samples; (f) evaluating the plurality of new bit string samples based on the plurality of cost function values of the plurality of filtered bit string samples; (g) selecting a subset of the plurality of filtered bit string samples based on the evaluation; (h) merging the first dataset with the subset of the plurality of filtered bit string samples to generate a second dataset; and (g) iteratively repeating (c) through (h), wherein in each iteration the output of (h) provides the input to (c) until reaching a limiting number of iterations.

The properties of the plurality of new bit string samples may include cardinality constraints. The properties of the plurality of new bit string samples may include frequency of appearance. The prior probability distribution may include initial observations and cost function values. The method may further include drawing the initial observations from randomly selected data elements in the first dataset.

Operation (b) may include using matrix product states (MPS) to generate the quantum generative model. The quantum generative model may be implemented as a tensor network (TN). The quantum generative model may include a generative adversarial network (GAN). The evaluating may include evaluating the plurality of new bit string samples based on minimizing cost function values.

The method may be practiced in a stand-alone mode. The required number of cost function evaluations may be smaller than that of classical optimizers.

Operation (a) may include receiving the first dataset from an output of a first optimizer, and the method may boost performance of the first optimizer. The method may achieve lower minima of the cost function than the first optimizer. The first optimizer may be a classical optimizer.

The computer system may further include a quantum computer, which includes a plurality of qubits. Performing unsupervised training using the first dataset to generate the quantum generative model may include performing the unsupervised training on the quantum computer. The quantum generative model may include a quantum-assisted generative adversarial network (qa-GAN).

Another aspect of the present invention is directed to a computer system for performing a method for solving combinatorial optimization problems. The computer system may include: a classical computer including a processor, a non-transitory computer-readable medium, and computer program instructions stored in the non-transitory computer-readable medium. The computer program instructions, when executed by the processor, perform, on the computer system, the method. The method includes: (a) generating a first dataset, the first dataset comprising a plurality of bit string samples from a prior probability distribution, (b) performing unsupervised training using the first dataset to generate a quantum generative model; (c) using the quantum generative model to generate a plurality of new bit string samples; (d) filtering the new bit string samples according to properties of the plurality of new bit string samples to produce a plurality of filtered bit string samples; (e) applying a cost function to the plurality of filtered bit string samples to produce a plurality of cost function values of the plurality of filtered bit string samples; (f) evaluating the plurality of new bit string samples based on the plurality of cost function values of the plurality of filtered bit string samples; (g) selecting a subset of the plurality of filtered bit string samples based on the evaluation; (h) merging the first dataset with the subset of the plurality of filtered bit string samples to generate a second dataset; and (g) iteratively repeating (c) through (h), wherein in each iteration the output of (h) provides the input to (c) until reaching a limiting number of iterations.

The prior probability distribution may include initial observations and cost function values. The properties of the plurality of new bit string samples may include cardinality constraints. The properties of the plurality of new bit string samples may include frequency of appearance. The method may further include, before (b), performing initial cost function evaluations on a randomly selected data element in the first dataset.

Operation (b) may include using matrix product states (MPS) to generate the quantum generative model. The quantum generative model may be implemented as a tensor network (TN). The quantum generative model may be implemented as a generative adversarial network (GAN). The evaluating may include evaluating the plurality of new bit string samples based on minimizing cost function values.

Operations (a)-(g) may be performed in a stand-alone mode. 28. The required number of cost function evaluations may be smaller than that of classical optimizers.

Operation (a) may include receiving the first dataset from an output of a first optimizer, and wherein the method boosts performance of the first optimizer. The method may achieve lower minima than the first optimizer. The first optimizer may be a classical optimizer.

The system may further include a Quantum Circuit Associative Adversarial Network (QC-AAN). The system may further include a Quantum Circuit Born Machine (QCBM). The quantum generative model may be implemented using gate-based quantum circuits.

The system may further include a quantum computer, which includes a plurality of qubits. Performing unsupervised training using the first dataset to generate the quantum generative model may include performing the unsupervised training on the quantum computer. The quantum generative model may include a quantum-assisted generative adversarial network (qa-GAN).

The disclosed technology disclosed can be practiced as a system, method, device, product, computer readable media, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections. These recitations are hereby incorporated forward by reference into each of the following implementations.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2n×2n complex matrix representing the same overall state change on n qubits. A quantum circuit may thus be expressed as a single resultant operator. However, designing a quantum circuit in terms of constituent gates allows the design to conform to a standard set of gates, and thus enable greater case of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled E). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

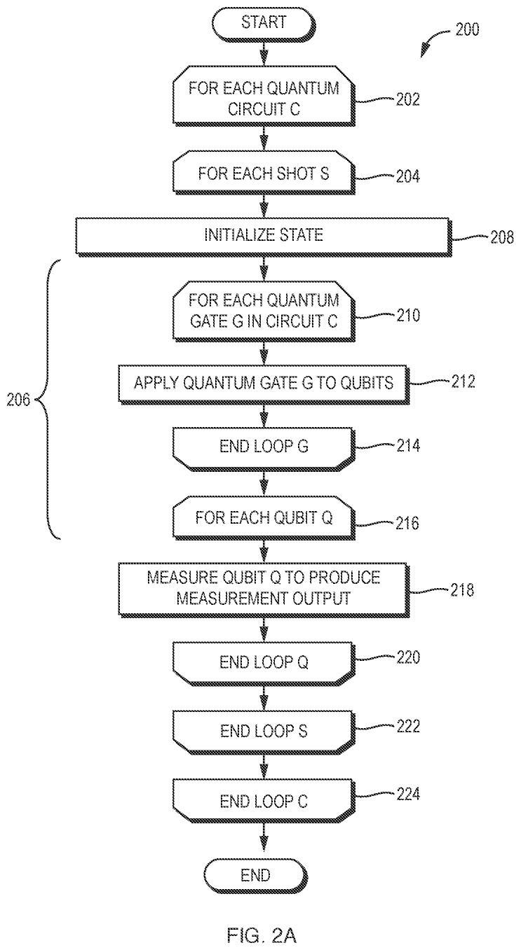

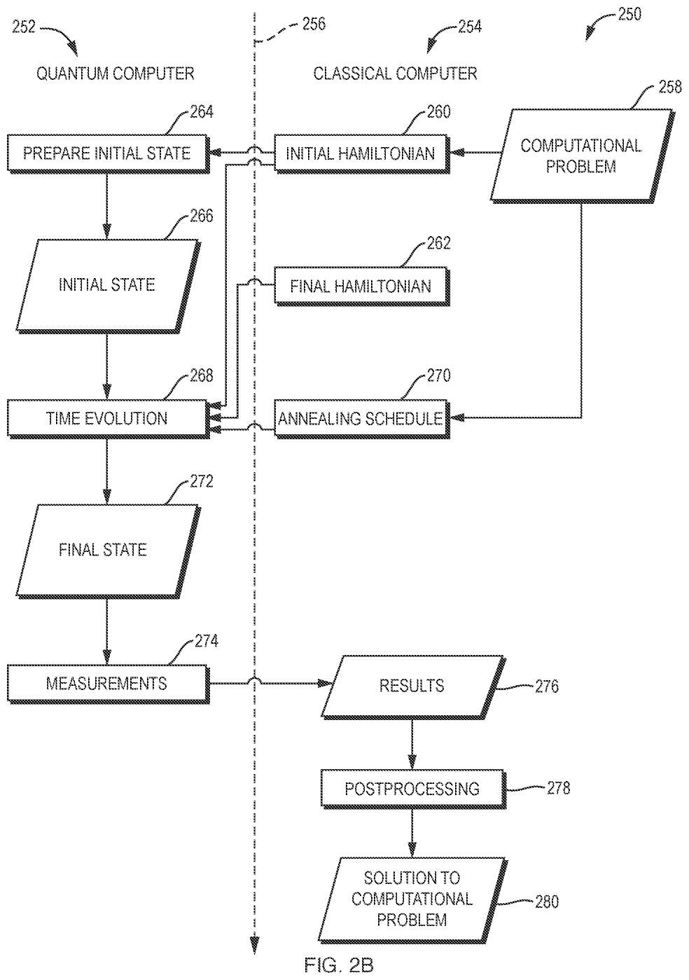

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original optimization problem 258. An experimental demonstration of the success of quantum annealing for random magnets was reported immediately after the initial theoretical proposal.

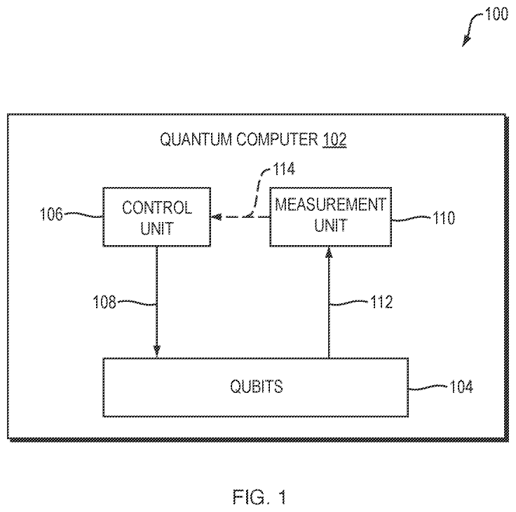

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback 114 from the measurement unit 110 to the control unit 106. Such feedback 114 is also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

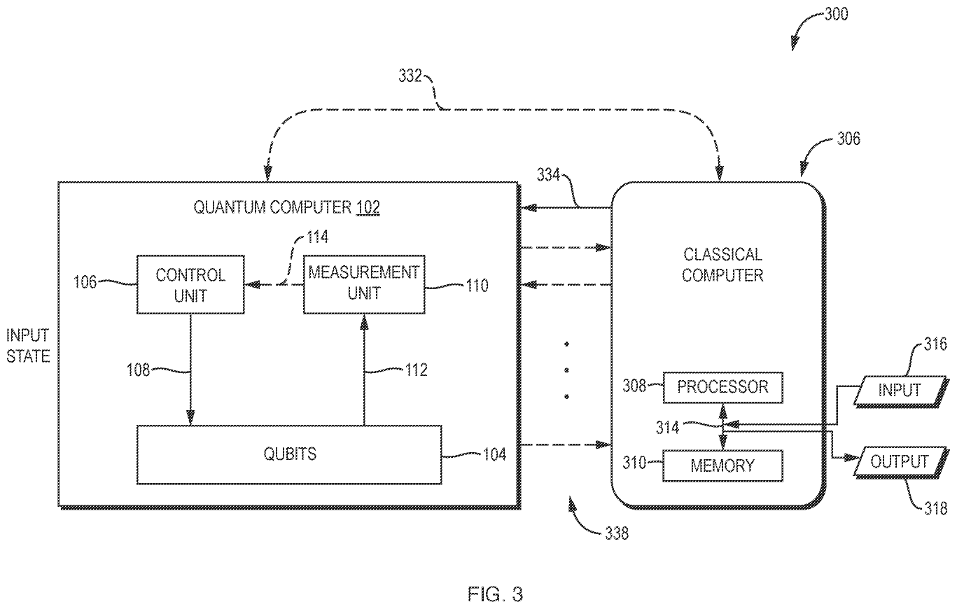

Referring to FIG. 3, a diagram is shown of a hybrid quantum classical computer (HQC) 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0> may alternatively refer to the state |1>, and vice versa. In other words, any role described herein for the states |0> and |1> may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention use a hybrid quantum-classical computer to perform unsupervised training using the first dataset to generate a quantum generative model. Such an action is inherently rooted in computer technology and cannot be performed mentally or manually by a human.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by a computer system for solving combinatorial optimization problems, the computer system comprising a classical computer, the classical computer including a processor, a non-transitory computer-readable medium, and computer instructions stored in the non-transitory computer-readable medium, the computer program instructions being executable by the processor to perform the method, the method comprising:
(a) generating a first dataset, the first dataset comprising a plurality of bit string samples from a prior probability distribution,
(b) performing unsupervised training using the first dataset to generate a quantum generative model;
(c) using the quantum generative model to generate a plurality of new bit string samples;
(d) filtering the new bit string samples according to properties of the plurality of new bit string samples to produce a plurality of filtered bit string samples;
(e) applying a cost function to the plurality of filtered bit string samples to produce a plurality of cost function values of the plurality of filtered bit string samples;
(f) evaluating the plurality of new bit string samples based on the plurality of cost function values of the plurality of filtered bit string samples;
(g) selecting a subset of the plurality of filtered bit string samples based on the evaluation;
(h) merging the first dataset with the subset of the plurality of filtered bit string samples to generate a second dataset; and
(g) iteratively repeating (c) through (h), wherein in each iteration the output of (h) provides the input to (c) until reaching a limiting number of iterations.

2. The method of claim 1, wherein the properties of the plurality of new bit string samples include cardinality constraints.

3. The method of claim 1, wherein the properties of the plurality of new bit string samples include frequency of appearance.

4. The method of claim 1, wherein the prior probability distribution comprises initial observations and cost function values.

5. The method of claim 4, further comprising drawing the initial observations from randomly selected data elements in the first dataset.

6. The method of claim 1, wherein (b) comprises using matrix product states (MPS) to generate the quantum generative model.

7. The method of claim 1, wherein the quantum generative model is implemented as a tensor network (TN).

8. The method of claim 1, wherein the quantum generative model comprises a generative adversarial network (GAN).

9. The method of claim 1, wherein the evaluating comprises evaluating the plurality of new bit string samples based on minimizing cost function values.

10. The method of claim 1, wherein the method is practiced in a stand-alone mode.

11. The method of claim 10, wherein the required number of cost function evaluations is smaller than that of classical optimizers.

12. The method of claim 1, wherein (a) comprises receiving the first dataset from an output of a first optimizer, and wherein the method boosts performance of the first optimizer.

13. The method of claim 12, wherein the method achieves lower minima of the cost function than the first optimizer.

14. The method of claim 13, wherein the first optimizer comprises a classical optimizer.

15. The method of claim 1, wherein the computer system further comprises a quantum computer, the quantum computer comprising a plurality of qubits.

16. The method of claim 15, wherein performing unsupervised training using the first dataset to generate the quantum generative model comprises performing the unsupervised training on the quantum computer.

17. The method of claim 15, wherein the quantum generative model comprises a quantum-assisted generative adversarial network (qa-GAN).

18. A computer system for performing a method for solving combinatorial optimization problems, comprising:
a classical computer including a processor, a non-transitory computer-readable medium, and computer program instructions stored in the non-transitory computer-readable medium;
wherein the computer program instructions, when executed by the processor, perform, on the computer system, the method, the method comprising:
(a) generating a first dataset, the first dataset comprising a plurality of bit string samples from a prior probability distribution,
(b) performing unsupervised training using the first dataset to generate a quantum generative model;
(c) using the quantum generative model to generate a plurality of new bit string samples;
(d) filtering the new bit string samples according to properties of the plurality of new bit string samples to produce a plurality of filtered bit string samples;
(e) applying a cost function to the plurality of filtered bit string samples to produce a plurality of cost function values of the plurality of filtered bit string samples;
(f) evaluating the plurality of new bit string samples based on the plurality of cost function values of the plurality of filtered bit string samples;
(g) selecting a subset of the plurality of filtered bit string samples based on the evaluation;
(h) merging the first dataset with the subset of the plurality of filtered bit string samples to generate a second dataset; and
(g) iteratively repeating (c) through (h), wherein in each iteration the output of (h) provides the input to (c) until reaching a limiting number of iterations.

19. The system of claim 18, wherein the prior probability distribution comprises initial observations and cost function values.

20. The system of claim 18, wherein the properties of the plurality of new bit string samples include cardinality constraints.
